(19) United States
(12) Patent Application Publication
(10) Pub. No.: US 2008/0076445 A1
(43) Pub. Date: Mar. 27, 2008

(54) Enterprise scheduling system

(76) Inventor: Aaron Hollander, Weston, CT (US)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 11/506,727

(22) Filed: Aug. 18, 2006

(51) Int. Cl. H04Q 7/20

(52) U.S. Cl. 455/456.1

(57) ABSTRACT

A system is disclosed in which maps and travel directions are generated, on the basis of subjective criteria input by a user in a particular business with certain transportation/logistics patterns in a mapping and travel direction inquiry, using data comprising objective geographic road data and subjective links to selectable criteria. The disclosed method of generating driving direction information, comprises creating a database comprising roads and subjective assessment information, of at least one type, associated with at least some of the roads. A driving direction information request associated with at least one of the subjective assessment information types is received from a requester. Driving direction information based, at least in part, on the subjective assessment information is generated and transmitted to the requester.

The subjective assessment information includes the identification of the class of the requester. The generation of driving direction information is based more heavily on data collected from individuals of the specified class of requesters.

### TECHNICAL FIELD

The present invention relates to the generation of maps and directions in response to a consumer inquiry, especially inquiries specifying a starting point and an ending point.

### BACKGROUND OF THE INVENTION

One of the services which has come out of the information age is the generation of customized travel directions and maps. These have largely supplanted the traditional use of travel maps where the traveler has the opportunity to access the Internet prior to making a trip. Such products are generally accessible through the Internet.

With such products, prospective users sign on to the website of the provider and provide their planned travel information. The provider then generates travel directions and/or map information which is returned to the user. This information may then be printed or stored on the hard drive or flash memory of the computer or other device for later retrieval.

Such systems operate on databases of information compiled by and made available in the United States by the government. For example, databases currently exist where, for each portion of a road or street, many dozens of items of information of a wide array of sorts are available. Such information may include street numbers, speed limits, number of lanes, traffic information, general nature, and so forth.

Today, numerous devices may be used to download maps and travel directions based on such information. These include conventional personal computers hardwired to the Internet through modems connected to Internet service providers. Likewise, such services may be accessed by handheld devices, such as Blackberry brand handheld communicators, Treo brand handheld e-mail devices, and ultrasmall/ultralight personal computers incorporating wireless communications devices, such as PCMCIA based wireless modules (having substantially wider bandwidth and greater speed as compared to handheld communicators), which are plugged into such personal computers.

Among the most well-known mapping/travel direction products is that provided under the trademark MapQuest. Using this product, a consumer inputs a starting point for a journey and an ending point. The system generates driving directions including, for example, roads, turning directions, driving distances and drive time. The user is also provided with a map of the route, showing the surrounding area and offering panning and zooming functions. This map may also be stored or printed for later use together with the other materials, for example while driving in an automobile.

More sophisticated products give the user the opportunity to specify details respecting the route which he or she wishes to travel.

For example, one popular service allows the user to specify whether he wishes the shortest route or one which takes the least amount of time to travel. Still other websites offering travel direction and mapping services present patrons with more elaborate choices. For example, the Rand McNally website offers the patron selections between 1) fewer steps and more steps (presumably fewer steps being easier to follow and more steps being somewhat shorter), 2) the fastest route or the shortest distance, 3) units in miles or kilometers, and 4) an overview map and destination map, or text-only, or an overview map, step-by-step maps and a destination map, with the option of showing total accumulated distance for each step.

### SUMMARY OF THE INVENTION

While such flexibility in the provision of information by travel direction and mapping services is useful, such objective criteria only go so far in assisting travelers in making informed driving choices. For example, drivers are often in the position of having to refer to traffic reports, for example those broadcast on television in map form showing blockages and bad traffic conditions. Ideally, the traveler would then correlate information and, perhaps, break the trip into several segments in an attempt to generate a map without segments with less than tolerable traffic.

In accordance with the present invention, maps and travel directions are generated, on the basis of subjective criteria input by the user in a mapping and travel direction inquiry, using data comprising objective geographic road data and subjective links to selectable criteria. More particularly, in accordance with the present invention, such subjective criteria are implemented as biases associated with the inventive system's selection of roads.

More particularly, in accordance with the invention a method of generating driving direction information, comprises creating a database comprising roads and subjective assessment information, of at least one type, associated with at least some of the roads. A driving direction information request associated with at least one of the subjective assessment information types is received from a requester. Driving direction information based, at least in part, on the subjective assessment information is generated and transmitted to the requester.

The subjective assessment information includes the identification of the class of the requester. In accordance with the invention, the generation of driving direction information is based more heavily on data collected from individuals of the specified class of requesters.

The creating of a database is initiated by advertising on a website featuring travel direction information offerings and functionality.

Positive and negative information is collected with respect to roads. In addition, information may be collected with respect to the reason for which the individual providing the information for the database is traveling on a road being assessed.

The database may receive information during the same period of time during which it is providing information to users.

In accordance with the preferred embodiment, information in the database is assigned a lifespan, the information being removed from the database as the lifespan expires.

In accordance with a preferred environment of the invention, individuals providing information during the creation of the database are queried as toward whether they are motorcycle enthusiasts or families traveling with small children. Requesters of driving directions may specify a road favored by motorcycle enthusiasts or families traveling with small children.

A requester may specify a number of subjective assessment items to design a driving direction generation function tailored to the requester's specific needs. Such features may include the requester specifying a starting point and an ending point for a journey. The requester may also specify one or more intermediate points in an itinerary in addition to a starting point and an ending point.

A requester may also specify a number of subjective assessment items to design a driving direction generation function tailored to the requester's specific needs. The driving directions are then provided in accordance with such specified subjective assessment items to the extent that statistically sound results can be provided, or, where statistically sound results cannot be provided, the closest statistically sound driving directions are provided instead. In this case, the requester may be informed of the parameters of the driving directions sent to the requester.

In accordance with a preferred embodiment of the invention, those individuals receiving driving direction information are contacted later for their feedback. This may be done by pop-up e-mails when they next visit the website which provided the driving directions.

In accordance with one embodiment of the invention, time of day information is obtained from the requester and associated with the assessment information.

The inventive system may be implemented by biasing speed or distance to reflect any preference, and thus skew an algorithm based on minimizing time of travel or distance traveled respectively.

### BRIEF DESCRIPTION OF THE DRAWINGS

These and other objects of the invention will become apparent from the following description taken together in conjunction with the drawings, which only illustrate several embodiment of the invention, and in which:

FIG. 1 is a block diagram of the method process/software for practicing the method of the present invention;

FIG. 2 is a schematic diagram of a system utilizing the method of the present invention;

FIG. 3 is a block diagram of an alternative embodiment of the inventive method process/software;

FIG. 4 is a block diagram of another alternative method process/software for practicing the method of the present invention; and

FIGS. 5-8 illustrate a portion of a graphic user interface for use in conjunction with the method of the present invention.

### DETAILED DESCRIPTION OF THE PREFERRED EMBODIMENTS

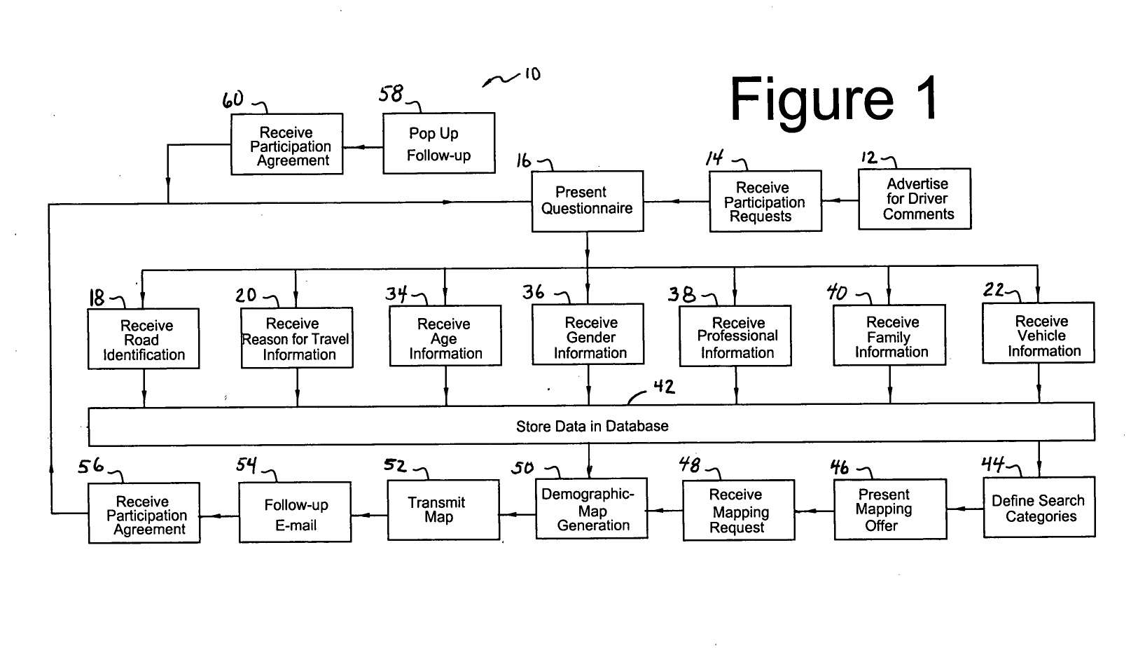

Referring to FIG. 1, the method 10 of the present invention may begin with a subjective information gathering step 12. More particularly, information may be gathered by advertising for comments from drivers. Such advertising is done, for example, over the Internet with a pop-up advertisement which says, for example: “Tell us about your favorite road”. Negative information may also be gathered, for example, with a pop-up advertisement which says: “Tell us about the road you never want to be on again!” Alternatively, the ad may simply be an invitation to participate in a survey. In accordance with the preferred embodiment, such advertising would be done on a website which is likely to be related to automobile travel, for example, a website offering maps and directions.

In response, viewers of the advertisement click on a link on, for example pop up advertisement, to generate a participation request which is received by the system at step 14. When the system receives such a participation request, it presents to the person responding to the pop-up advertisement a questionnaire which is presented at step 16.

The questionnaire may take any one of numerous questionnaire formats known in the art. In accordance with the invention, however, information may be sent to a database as it is received in order that information will be gathered, from forms which are only partially filled out. The system may be programmed to assess the value of the data and use it to the extent it is believed to be valuable, where the data is incomplete.

In accordance with the invention, it is contemplated that the questionnaire will request data from a survey participant in a number of areas. For example, the system along with requesting road identification data for most favorite and least favorite roads, for example, or perhaps only a most favorite road or roads, or alternatively the most favorite road at step 20. The system also requests the reason for which the person travels that road at step 20. This along with vehicle information received at step 22 comprises core information in providing subjective/objective information to individuals requesting travel and mapping information.

In addition, the system may also request other information which would be useful in providing the subjective/objective travel and mapping information. This may include receiving participant age information at step 34, receiving gender information at step 36, receiving information about the type of work a person does at step 38, and receiving information about the size and nature of the family to which the person responding to the survey belongs at step 40.

As the information is accumulated, or after all information has been accumulated, at steps 18, 20, 22, 34, 36, 38 and 40, answers are downloaded to database 42. In accordance with the present invention, it is contemplated that database 42 may contain data which is periodically updated by user inputs. Likewise, in accordance with the invention, information, depending on its nature, is periodically purged. This is done in order to keep the system current and with a maximized utility and reliability.

Once enough information has been stored in the database at step 42, appropriate search categories are defined at step 44. For example, for individuals who ride motorcycles, a search category for motorcycles may be defined. Likewise, if there is a sufficient quantity of data respecting families with children under seven, or under fifteen, such a category may also be defined.

In accordance with the invention, maps and travel directions are offered at step 46 to users of the system on a screen which includes blanks for the address of the starting point, the address of the destination, and a selection of a route type statistically most favored by, for example, bikers, families traveling with children under seven, or salesman making sales calls.

In accordance with the invention, it is contemplated that in addition to predefined search categories, as are presented at step 44, to the extent that data is available, a user can design a search category, and his reason for travel (for example travel to a single point, travel for a scenic drive, travel along a route with attractions for children), the family circumstances associated with the travel, the gender of the driver, and so forth. In addition, the person making a request for map and or travel directions may specify which of the factors in the profile is most important to the user.

In accordance with the present invention, it is also contemplated that the user will have the option of filling in more than starting point and ending point addresses if the user wishes to make a plurality of stops.

After an offer of a map and or travel directions is made at step 46, the same may result in the consumer contacting the website of the operator of the inventive system and sending in a mapping/driving directions request at step 48. This request, as noted above, includes subjective preference information, such as routes favored by families traveling with small children, routes favored by motorcycle enthusiasts, and so forth.

After a request for travel directions and/or mapping is received at step 48, the system proceeds to step 50 where the information in database 42 is consulted. In the event that there is sufficient statistical data, a map can be generated at step 50, which is precisely tailored to the demographic preferences of the user. Alternatively, it may be a map simply keyed to a particular category, such as roads preferred by motorcycle enthusiasts. The map and/or travel directions are then transmitted at step 52 to the user.

In accordance with the invention, in order to keep the database up to date, several techniques may be used to continue to gather more information. In addition to optional further advertising at step 12, the system sends e-mails at step 54 to inquire respecting previously sent information. If the user accepts participation in a follow-up survey the same is received at step 56. The system then proceeds to present a follow-up questionnaire at step 16 to the user. This follow-up questionnaire does not repeat basic information but is designed to gather information to measure the accuracy of the previously furnished information and the satisfaction of the user with the information presented at step 52. After presenting the follow-up questionnaire at step 16, the system proceeds to the information gathering steps in the manner indicated above.

In addition, the system may present a pop-up follow up message the next time that the user of the service signs on to the website, as indicated at step 58. Upon receipt of an indication of agreement to participate at step 60, the system again proceeds to step 16 and presents a follow-up questionnaire. Once again, after presenting the follow-up questionnaire at step 16, the system proceeds to the information gathering steps in the manner indicated above.

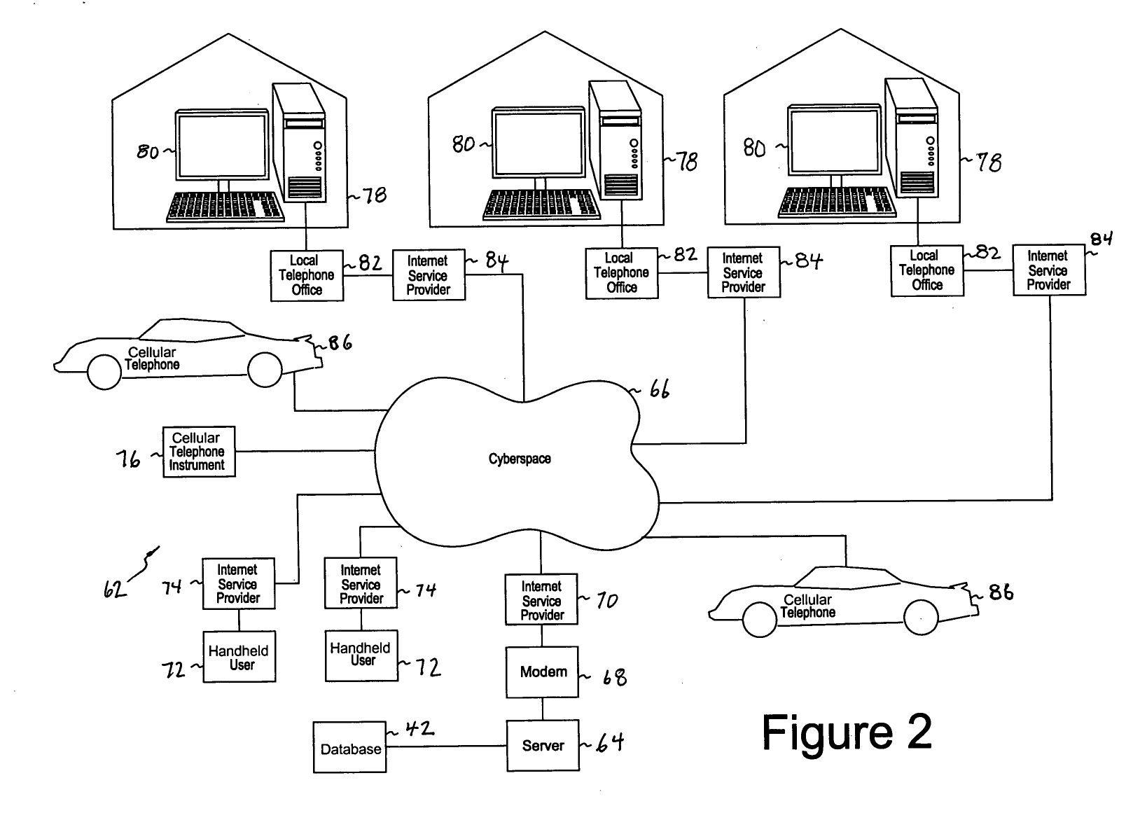

A system 62, for implementing the method of the present invention, is illustrated in FIG. 2. Generally, a server 64 consults with database 42 and communicates with cyberspace 66 via a modem 68 and Internet service provider 70. Users, including handheld users 72, may access the system through their Internet service providers 74. In principle, the system may also be accessed by texting by a cellular telephone user 76. However, it is contemplated that the most common user will be based, perhaps at a home or office 78 and using a personal computer 80, accessing the Internet through a modem connected to the local telephone office 82, through its Internet service provider 84. In accordance with the invention, it is also contemplated that users with cellular telephone/portable e-mail service and located in automobiles 86 will also access the system.

The following are descriptions of alternative embodiments of the invention. For purposes of organization, where possible, corresponding functions or analogous method steps have been given numbers which differ from the embodiment of the invention illustrated in FIG. 1 by multiples of 100.

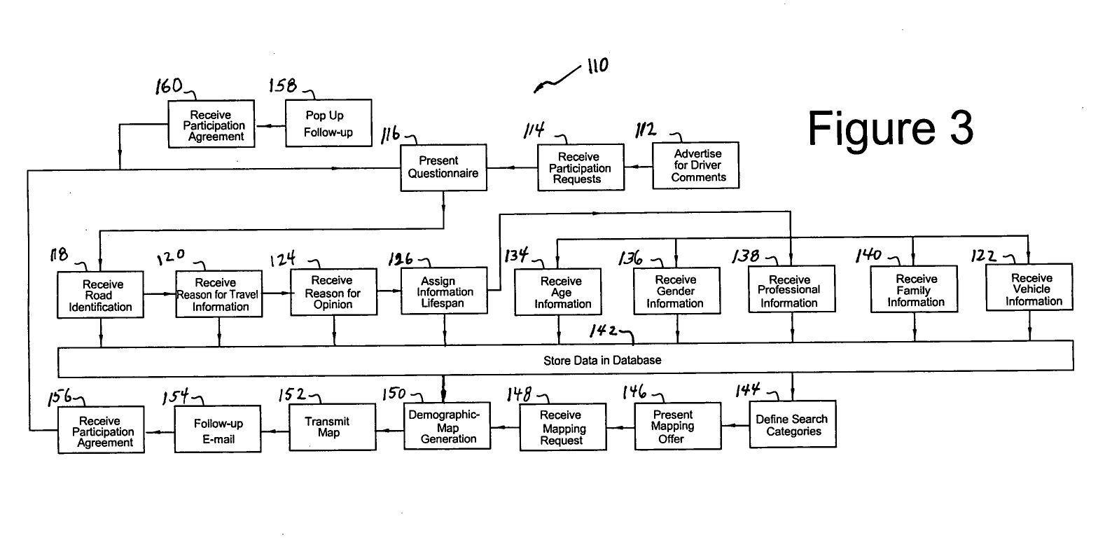

Referring to FIG. 3, the method 110 of the present invention may begin with a subjective information gathering step 112. More particularly, information may be gathered by advertising for comments from drivers. Such advertising is done, for example, over the Internet with pop-up advertisements of suitable content.

In response, viewers of the advertisement click on the pop-up advertisement to generate a participation request which is received by the system at step 114. When the system receives such a participation request, it presents to the person responding to the pop-up advertisement a questionnaire which is presented at step 116.

The questionnaire may take any one of numerous questionnaire formats known in the art, or as described above. In accordance with the invention, information may be sent to a database as it is received in order that information will be gathered, even in cases where questionnaires are only partially filled out, and the system may be programmed to assess the value of the data and use it to the extent it is believed to be valuable.

In accordance with the invention it is contemplated that the questionnaire will request data from a survey participant in a number of areas. For example, the system along with requesting road identification data, for example most favorite road at step 118, will also request reason for travel information at step 120. This, along with vehicle information received at step 122, comprises core information in providing subjective/objective information to individuals requesting travel and mapping information.

In accordance with the invention, information respecting the reason for the good or bad opinion of a particular road is collected at step 124. For example, the system may present various choices such as traffic, scenery, restaurants, and so forth. This information may then be used to define user map and driving direction categories and provide information to users with various interests, as detailed above.

Likewise, information input at step 124 may be used to determine the lifespan in the database for the report. For example if the reason for the good opinion is a street carnival, the report should have, for example, only a few days lifespan. If the reason is scenery, then the report should be assigned a lifespan of relatively long duration, for example ten years. Such lifespan is assigned at step 126.

In addition, the system may also request other information which would be useful in providing the subjective/objective travel and mapping information. This may include receiving age information at step 134, receiving gender information at step 136, receiving information about the type of work a person does at step 138, and receiving information about the size and nature of the family to which the person responding to the survey belongs at step 140.

As the information is accumulated, or after all information has been accumulated, at steps 118, 120, 122, 134, 136, 138 and 140, such information is downloaded to a database at step 142. In accordance with the present invention, it is contemplated that downloading of information to the database at step 142 is dynamic and constantly updated by user inputs.

Likewise, in accordance with the invention, information, depending on its nature, as detailed above, is periodically purged. This is done to keep the information current and with a maximized utility and reliability.

Once enough information has been stored in the database at step 142, appropriate search categories are defined at step 144. From that point, the use and updating of the databases are analogous and similar to that of the system illustrated in FIG. 1, including pop-up follow-up at step 158 and presentation of a questionnaire at step 116, in response to receipt of a participation agreement at step 160.

After an offer of a map and or travel directions is made at step 146, the same may result in the consumer contacting the website of the operator of the inventive system and sending in a mapping/driving directions request at step 148.

After a request for travel directions and/or mapping is received at step 148, the system proceeds to step 150 where the information in database 142 is consulted to generate a map which is sent at step 152.

For example, in addition to optional further advertising a step 112, the system may send pop-up e-mails at step 154 to inquire respecting the experience of the user. If the user accepts participation in a follow-up survey the same is received at step 156. The system then proceeds to present a follow-up questionnaire at step 116 to the user.

The system may present a pop-up follow up message the next time that the user of the direction service signs on to the website as indicated at step 158. Upon receipt of an indication of agreement to participate at step 160, the system proceeds to step 116 and presents a follow-up questionnaire.

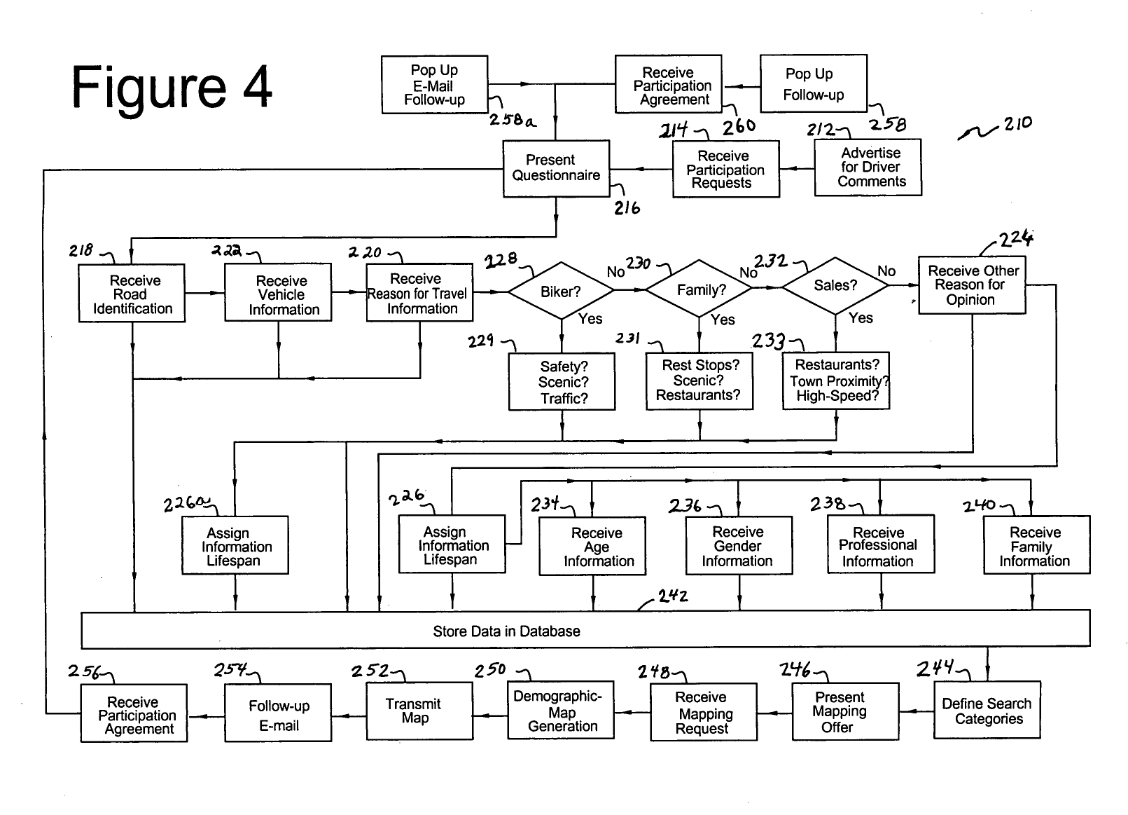

Referring to FIG. 4, another alternative method 210 in accordance with the present invention may begin with a subjective information gathering step 212. In response, viewers of an advertisement click on the pop-up advertisement to generate a participation request which is received by the system at step 214. When the system receives such a participation request, it presents, to the person responding to the pop-up advertisement, a questionnaire which is presented at step 216.

The questionnaire may take any one of numerous questionnaire formats known in the art, or as described above. In accordance with the invention, information may be sent to a database as it is received in order that information will be gathered, even in cases where questionnaires are only partially filled out, and the system may be programmed to assess the value of the data and use it to the extent it is believed to be valuable.

In accordance with the invention, it is contemplated that the questionnaire will request data from a survey participant in a number of areas. For example, the system along with requesting road identification data for example most favorite road at step 218, will also request reason for travel information at step 220. This along with vehicle information received at step 222 comprises core information in providing subjective/objective information to individuals requesting travel and mapping information.

In accordance with the embodiment of the invention illustrated in FIG. 4, it is contemplated that the system will determine whether the survey participant falls into one of a number of classes. For example, at step 228 it could determine whether the individual is a motorcycle enthusiast. At step 229, if the individual is a motorcycle enthusiasts it could query whether the opinion is based on the safety of the road, the scenic value of the road or traffic, for example.

Similarly, if the individual is not a motorcycle enthusiast, the system will, for example, determine whether it is a family traveling with small children at step 230. If, at step 230, it is determined that the respondent is answering for a family traveling with small children, at step 231 the system may put out an inquiry in multiple choice format asking whether the reason for the opinion is the easy availability of rest stops, the scenic nature of the drive, or the convenience of restaurant dining.

If respondent is not a motorcycle enthusiast or an individual answering for a family traveling with small children, at step 232 the system can determine whether the respondent is in a sales profession. If, at step 232, it is determined that the respondent is in a sales profession and thus has very different needs from others with respect to a route of travel, at step 233 the system may put out an inquiry in multiple choice format asking whether the reason for the opinion is the convenience of restaurant dining, proximity to towns or quickly moving traffic, as these factors are of interest to, for example, a salesman.

In accordance with the invention, information respecting other reasons for the good or bad opinion of a particular road is collected at step 224. Such information is analyzed and organized to be included in user category databases to be querried in response to users in such categories requesting maps and/or directions. For example, the system may present various choices such as traffic, scenery, restaurants, and so forth. This information may then be used to define user map and driving direction categories and provide information to users with various interests, as detailed above.

Likewise, information input at step 224 may be used to determine the lifespan for the report. Such lifespan is assigned at step 226. In similar fashion, reasons for the opinion collected from motorcycle enthusiasts, families traveling with small children and salespeople may be assigned a lifespan at step 226a. When the lifespan for a particular item has run, it is removed from database 242.

In addition, the system may also request other information which would be useful in providing the subjective/objective travel and mapping information. This may include receiving age information at step 234, receiving gender information at step 236, receiving information about the type of work a person does at step 238, and receiving information about the size and nature of the family to which the person responding to the survey belongs at step 240.

As the information is accumulated, or after all information has been accumulated, at steps 218, 220, 222, 234, 236, 238 and 240, the same is downloaded to a database at step 242. In accordance with the present invention, it is contemplated that downloading of information to the database at step 242 is dynamic and constantly updated by user inputs. Likewise, in accordance with the invention, information, depending on its nature, as detailed above, is periodically purged. This is done in order to keep the information current and with a maximized utility and reliability.

Once enough information has been stored in the database at step 242, appropriate search categories are defined at step 244. From that point, the use and updating of the databases is analogous and similar to that of the system illustrated in FIG. 1, including pop-up follow-up advertising at step 258 and presentation of a questionnaire at step 216 in response to receipt of a participation agreement at step 260. Alternatively, or in addition, a pop-up e-mail to the user of the website may be presented at step 258a.

After an offer of map and or travel directions is made at step 246, the same may result in the consumer contacting the website of the operator of the inventive system and sending in a mapping/driving directions request at step 248.

After a request for travel directions and/or mapping is received at step 248, the system proceeds to step 250, where the information in database 242 is consulted to generate a map which is sent at step 252.

For example, in addition to optional further advertising at step 212, the system may send pop-up e-mails at step 254 to inquire respecting the experience of the user. If the user accepts participation in a follow-up survey the same is received at step 256. The system then proceeds to present a follow-up questionnaire at step 216 to the user.

The system may present a pop-up follow up message the next time that the user of the service signs on to the website as indicated at step 258. Upon receipt of an indication of agreement to participate at step 260, the system proceeds to step 216 and presents a follow-up questionnaire.

In accordance with the present invention, it is also contemplated that the various embodiments of the method of the present invention may also include the collection of data on the time of day that the respondent uses the road and associate the same with the opinion of the road which the individual responding to the questionnaire has provided. This information can then be used to provide a customization opportunity for the person requesting driving directions or a map. For example, the request form for driving directions, in addition to showing the beginning point and endpoint of the journey and all the other information in accordance with the present invention may also include a selection of a time of day for travel, for example, morning rush hour, morning, noon, afternoon, evening rush hour, evening, and after midnight.

In accordance with the present invention, it is also contemplated that the inventive system may be made available to a particular group, for use only by that particular group. For example, the inventive system may be implemented on a private network. Alternatively, instead of giving a user the option of selecting, for example, shortest route, shortest time or most scenic, the website may include a further selection which says “Proprietary User Sign in”.

For example, the inventive system may be implemented at a company which provides parcel delivery, such as UPS. If the user clicks “Proprietary User Sign in”, the user may be prompted to input a user-name and password. Once this information has been input by the user and this test has been successfully completed by the user, the user is given access to the system, and to the proprietary database which implements the type of routes which the user's organization has decided to make available to its, for example, employees.

The operation of such a proprietary experience-based system may be understood with reference to a parcel delivery service. For example, in such a system, biasing effects implemented by the system may take into account time based information.

For example, the proprietary information input into the system may be the frequency with which particular roads or streets are traveled at a particular time of the day. In accordance of the present invention it is contemplated that system inputs may be input in an automated fashion, for example, by a computer system which has received package pickup requests as a result of e-commerce over the Internet, or, by way of an alternative example a regular stop request from a particular customer, whether or not packages are present on a particular day to be picked up. Such information may generate bias information on a historical basis as well as generate routing instructions on an ongoing basis.

More particularly, proprietary information in the database may indicate that a particular portion of a street has business for the parcel service only in the afternoon. Thus, a system input to the effect of requesting a stop at a particular location which experience shows only has business in the afternoon or which is located on a street which is characterized by afternoon business, would result in a route design by the system heavily biased toward stopping at such location or traveling along such street at such a point in the route which is likely to result in such stop being made in the afternoon.

A similar arrangement may be used by a police department in connection with the answering of calls, where routes in low priority or routine cases would be subjected to modification in response to enterprise specific biases which result in increasing the likelihood of a route output by the system passing through neighborhoods or going down streets or roads, where problems are likely to be encountered, or calls likely to be made requesting police help.

In accordance with the present invention, it is contemplated that biases may take the form of altering the algorithm determinative parameter. More particularly, map and direction generating systems generally operate by selecting a particular parameter of the dozens of parameters associated with a particular road segment, for operation of the system. For example, if the user wishes to take a minimal mileage route, prior art systems operate on the database of road and street segment information sets by looking at the distance information associated with each particular segment of each road which may be used to generate a user specific route map.

In accordance with the present invention, this particular parameter may be biased up or biased down. For example, if a road is selected by motorcycle fans 80% of the time, and the system algorithm is based upon lowest mileage, the mileage of the road segment may be decreased to correspond to the degree of favor of motorcycle fans for route map generations input by persons requesting the motorcycle fan's preference. For example, if 80% of motorcycle fans select a particular road, mileage may be reduced by 20%, while if only 50% of motorcycle fans select a particular road, mileage may only be reduced by 10%, thus skewing a low mileage preference algorithm appropriately.

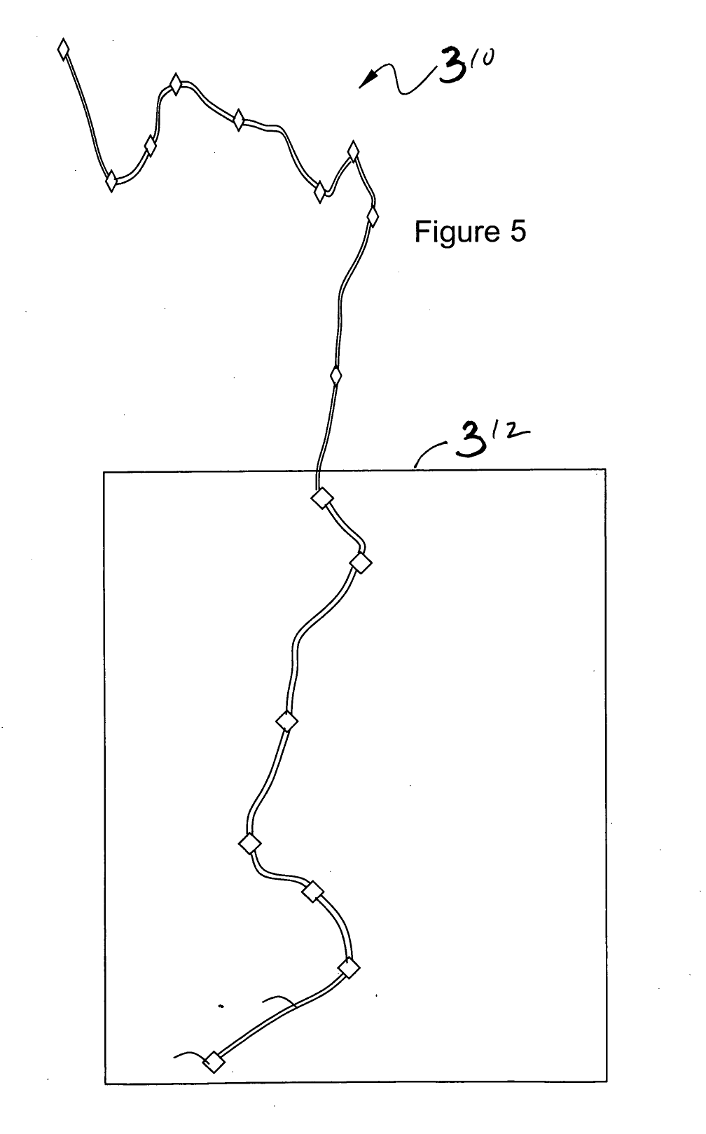

Referring to FIG. 5, a personalized route map 310 generated by the system is illustrated. Such a route map may be accompanied by written directions or any other sorts of information typically included with maps generated by computer-based systems today. In most respects, map 310 resembles maps generated by prior art systems. In accordance with the invention, however, if a user decides that he or she wishes to rate a particular section of the route, this can be done over the Internet by going to the website of the map provider. In accordance with the invention, the website may provide a menu of previously generated maps upon the user's signing in or merely going to the website. The user then sees an entry corresponding to the map generated in response to the inquiry which generated the map of FIG. 5.

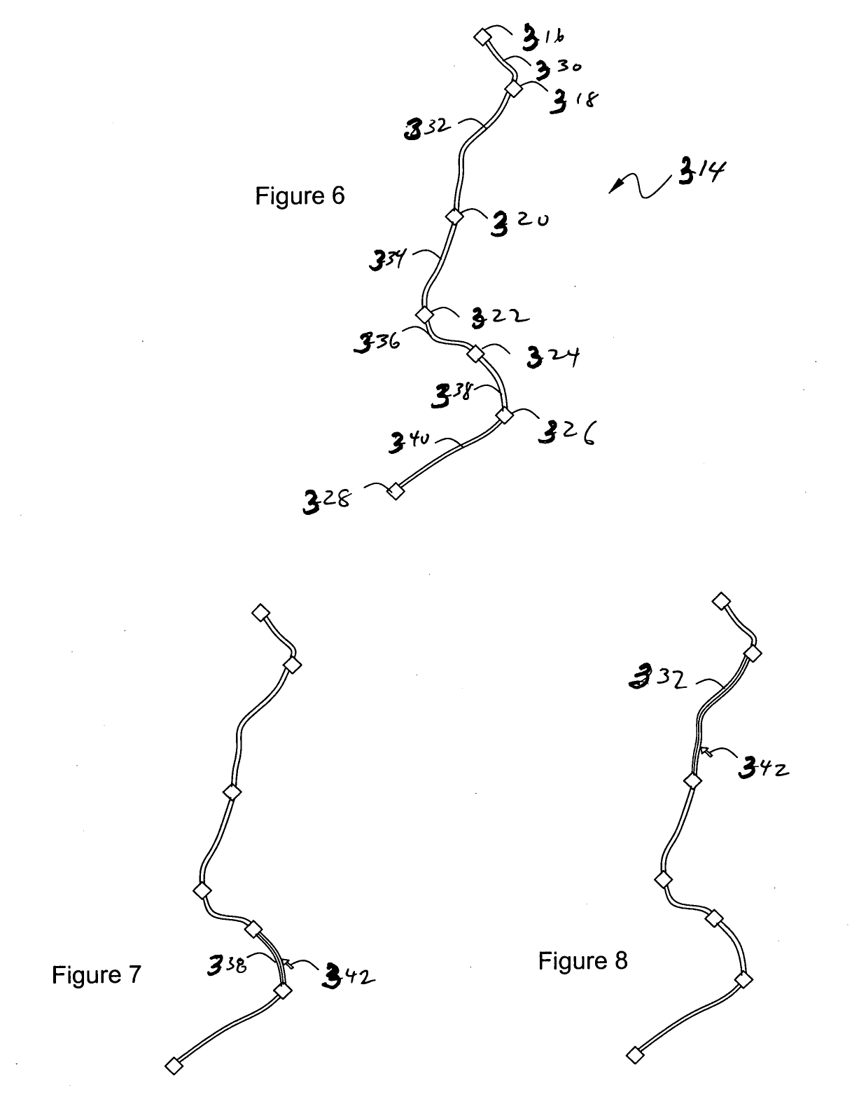

The user then clicks on that entry and the map illustrated in FIG. 5 is displayed. If the user wishes to rate a particular segment of the map, the user may use his mouse to drag a box 312 over that portion of the map to be rated. The system then generates a map such as that illustrated in FIG. 6.

The user is then presented with an on-screen button which allows the user to select all portions of the illustrated segment. This may then be rated by the user through the presentation of a series of questions, preferably multiple-choice questions or questions with numerical answers to allow for automated handling of the information. Alternatively, plain English or other language responses may be entered into the system and artificial intelligence used to generate information, assign reliability data to the same and factor the same into selection criteria for future map generation.

More particularly, it is noted that map segment 314 includes a plurality of interchange points 316-328, and a plurality of road segments 330-340. The option may also be presented to edit a particular boxed map segment such as that illustrated in FIG. 6. For example, the right button may be clicked to deselect segments, or to select segments. One possibility is to put a button on the web page which says to “Deselect All Road Segments”, or “Select All Segments”.

For example, if the user clicked on the button which says “Deselect All Road Segments” and then put the cursor on road segment 338, and clicked, the display may take the form shown in FIG. 7 where the segment to be rated, namely segment 338, is visually emphasized. The left mouse button may be used for such clicking to show a segment to be rated. Alternatively, the user may drag boxes, as illustrated in FIG. 5 to select subportions of the route. Yet another option is for the right mouse button to be used to unselect portions of a map segment.

In accordance with the present invention, after the clicking of the button which allows the deselection of all portions of the map, the user may, on a magnified map segment select, for example, portion 338 by using the left mouse button. The result may be a map such as that illustrated in FIG. 8. The user is then presented with the questions for rating of portion 238. After this is completed, the user may unselect portion 338 (by clicking with the right mouse button, for example) and click on portion 332 using the left mouse button to select portion 332. Upon the entry of a new selection, a dialog box inviting rating of the new selection may be presented. Such dialog boxes include a button to begin the rating process.

In accordance with the present invention, it is contemplated that the user may continue to adjust the extent of the portion to be rated prior to clicking on the button to begin the rating process.

Yet another feature of the invention involves the generation of feedback and the presentation of an alternative to the user of the system. For example, if a selected route results in the selection of a street having a tendency toward flooding, such information may be presented to the user. Moreover, if desired, the user may be sent a message indicating the problem and asking if the user wishes an alternative.

In accordance with a particular preferred embodiment of the invention, extraneous data, such as weather reports, may be used to determine whether the possibility of flood is substantial and thus whether the user should be sent such a message.

In connection with the above, it is also contemplated that the user will be provided with the opportunity of inputting the date and time of travel and this information may be used, together with weather data, traffic, and the like to determine potential problems and present alternatives to the user in advance.

Still yet another alternative in accordance with the invention is the receipt of map correction data from individual users. This data may be received by selection of a particular map segment and a user report in words of the correction to the map.

While only several illustrative embodiments of the invention have been described, it is understood that modifications will be apparent to those of ordinary skill in the art on the basis of the above description and the associated figures. For example, information may be input into the system through the use of global position system (GPS) information or the like. Such modifications are within the spirit and scope of the invention which is limited and defined only by the appended claims.

1. A method of generating driving direction information, comprising:
(a) creating a database comprising roads and subjective assessment information, of at least one type, associated with at least some of said roads, said subjunctive information being specific to an enterprise associated with said enterprise;
(b) receiving, from a requester a driving direction information request associated with at least one of said subjective assessment information types;
(c) generating driving direction information based, at least in part, on said subjective assessment information; and
(d) transmitting said driving direction information to said requester.

2. A method as in claim 1, wherein said subjective assessment information includes the identification of the class of the requester, and wherein said generating driving direction information is based more heavily on data collected from individuals of the specified class of requesters.

3. A method as in claim 1, wherein said creating of a database is done by advertising on a website featuring travel direction information offerings and functionality.

4. A method as in claim 1, wherein positive and negative information is collected with respect to roads.

5. A method as in claim 1, wherein information is collected with respect to the reason for which the individual providing said information for said database is traveling on a road being assessed.

6. A method as in claim 1 wherein said database receives information during the same period of time during which it is providing information to users.

7. A method as in claim 1, wherein information in said database is assigned a lifespan, said information being removed from said database as said lifespan expires.

8. A method as in claim 1, wherein maps and travel directions are offered and provided.

9. A method as in claim 1, wherein individuals providing information during the creation of said database are queried as toward whether they are motorcycle enthusiasts or families traveling with small children, and wherein requesters may specify a road favored by motorcycle enthusiasts or families traveling with small children.

10. A method as in claim 1, wherein a requester may specify a number of subjective assessment items to design a driving direction generation function tailored to the requester's specific needs.

11. A method as in claim 1, wherein the requester specifies a starting point and an ending point for a journey.

12. A method as in claim 1, wherein a requester may specify one or more intermediate points in an itinerary in addition to a starting point and an ending point.

13. A method as in claim 1, wherein a requester may specify a number of subjective assessment items to design a driving direction generation function tailored to the requester's specific needs., and wherein driving directions are provided in accordance with such specified subjective assessment items to the extent that statistically sound results can be provided, or, where statistically sound results cannot be provided, the closest statistically sound driving directions are provided instead.

14. A method as in claim 1, wherein a requester may specify a number of subjective assessment items to design a driving direction generation function tailored to the requester's specific needs., and wherein driving directions are provided in accordance with such specified subjective assessment items to the extent that statistically sound results can be provided, or, where statistically sound results cannot be provided, the closest statistically sound driving directions are provided instead, and the requester is informed of the parameters of the driving directions sent to the requester.

15. A method as in claim 1, wherein individuals receiving driving direction information are contacted later for their feedback.

16. A method as in claim 1, wherein individuals receiving driving direction information are contacted later for their feedback by pop-up e-mails when they next visit the website which provided the driving directions.

17. A method as in claim 1, where in time of day information is obtained from said requester and the associated with said assessment information.

18. A method as in claim 1, wherein said driving directions are generated by an algorithm which is driven by a determinative parameter and said subjective assessment information is input into the algorithm by increasing or decreasing said determinative parameter.

19. A method as in claim 18, wherein said determinative parameter is mileage.
